(19) United States
(12) Patent Application Publication
(10) Pub. No.: US 2008/0009430 A1
(43) Pub. Date: Jan. 10, 2008

(54) Surfactants systems for cold water cleaning

(76) Inventors: Stacie Ellen Hecht, West Chester, OH (US); Eva Schneiderman, Mason, OH (US); Sherri Lynn Randall, Hamilton, OH (US); Marc Eric Gustwiller, Cincinnati, OH (US); Virginia Smith, Hattiesburg, MA (US); Clarence Anthony Turley III, Cincinnati, OH (US); Linda Carol McWilliams, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/820,373

(22) Filed: Jun. 19, 2007

Related U.S. Application Data
(60) Provisional application No. 60/919,684, filed on Mar. 23, 2007.
(60) Provisional application No. 60/814,929, filed on Jun. 19, 2006.

(51) Int. Cl. C11D 3/20

(52) U.S. Cl. 510/352

(57) ABSTRACT

Surfactant systems exhibiting a low Krafft Temperature provide cold water cleaning.

### CROSS REFERENCE TO RELATED APPLICATION

This application claims the benefit of U.S. Provisional Application No. 60/919,684, filed Mar. 23, 2007, which claims the benefit of U.S. Provisional Application No. 60/814,929, filed Jun. 19, 2006, the disclosures of which are incorporated by reference.

### FIELD OF THE INVENTION

Specific combinations of surfactants yield compositions suitable for cold water cleaning.

### BACKGROUND OF THE INVENTION

Sulfonated fatty acid alkyl ester surfactants, such as methyl ester sulfonate (“MES”), have long been regarded as effective surfactants. Given the increasing cost of petroleum, these surfactants are becoming particularly attractive since they can be manufactured using non-petroleum starting materials (such as palm oil). A disadvantage of MES is a relatively high Krafft Temperature, which makes the use of the surfactant in cold water cleaning applications unattractive. The Krafft Temperature has been described as the temperature at which the solubility of an ionic surfactant becomes equal to its critical micelle concentration; below the Krafft Temperature, surfactants form precipitates instead of micelles. Solutions to this problem have been reported. For example, it has been reported that reducing the formation of the di-salt form MES, verses the mono-salt variety, can lower the Krafft Temperature. To this end, it has been reported that the Krafft Temperature of a C₁₆ MES di-salt is 65° C., whereas the Krafft Temperature of the mono-salt form of C₁₆ MES is 17° C. See e.g., U.S. Pat. No. 6,780,830, col. 1, line 63 et seq. However, there is a continuing need to provide cleaning compositions that incorporate sulfonated fatty acid alkyl ester surfactants, such as MES, and yet provide Krafft Temperatures below about 15° C. or lower, to provide cold water cleaning.

### SUMMARY OF THE INVENTION

One embodiment of the present invention provides a laundry detergent composition comprising a surfactant system comprising: sulfonated fatty acid alkyl ester surfactant; an alkylbenzenesulphonate surfactant; a branched surfactant; an alkyl or alcohol sulfate surfactant, and a Krafft Temperature below about 15° C.

Another embodiment of the present invention provides for a laundry detergent composition comprising a surfactant system comprising: (a) from about 0.5 to about 35 parts by weight of a alkylbenzenesulphonate surfactant; (b) from about 40 to about 78 parts by weight of a branched surfactant; (c) from about 22 to about 49 parts by weight of a sulfonated fatty acid alkyl ester surfactant; and (d) a Krafft Temperature below about 15° C., wherein adding the parts by weight of the surfactants of (a)+(b)+(c) total to about 100 parts by weight of the surfactant system.

Another embodiment of the present invention provides for a laundry detergent composition comprising: from about 7 weight % to about 30 weight % of the laundry detergent composition of a surfactant system comprising: from about 35 to about 75 parts by weight of a alkylbenzenesulphonate surfactant; from about 10 to about 50 parts by weight of a branched surfactant; and from about 10 to about 30 parts by weight of the sulfonated fatty acid alkyl ester surfactant; and a Krafft Temperature below about 15° C., wherein adding the parts by weight of the surfactants of (a)+(b)+(c) total to about 100 parts by weight of the surfactant system, and wherein the laundry detergent composition is a granular or powder laundry detergent composition.

### DETAILED DESCRIPTION OF THE INVENTION

The present invention has found the surprising discovery that MES, when combined with other certain surfactants at certain weight ratios, can provide cleaning compositions with low Krafft Temperatures that are suitable for cold water cleaning.

It has been found that surfactant systems with Kraft Temperatures at or below about 15° C. provide effective cold water cleaning. As such, one aspect of the invention provides a surfactant system that provides cold water cleaning, comprising a Sulfonated Fatty Acid Alkyl Ester Surfactant and a Krafft Temperature below about 15° C., alternatively less than about 12.2° C., alternatively less than about 10° C., alternatively less than about 8° C., alternatively less than about 5° C.

Another aspect of the invention is directed to maximizing the amount of a Sulfonated Fatty Acid Alkyl Ester Surfactant in combination with other surfactants in the surfactant system but still maintaining a Krafft Temperature at or below about 15° C., alternatively less than about 12.2° C., alternatively less than about 10° C., alternatively less than about 8° C., alternatively less than about 5° C.

Yet another aspect of the invention is directed to surfactant systems comprising at least 56 parts by weight, alternatively at least 49 parts by weight, alternatively at least 30 parts by weight, alternatively at least 20 parts by weight, alternatively at least 10 parts by weight of a Sulfonated Fatty Acid Alkyl Ester Surfactant and a maintaining a Krafft Temperature at or below about 15° C., alternatively less than about 12.2° C., alternatively less than about 10° C., alternatively less than about 8° C., alternatively less than about 5° C.

The laundry detergent composition of the present invention comprises a surfactant system comprising a sulfonated fatty acid alkyl ester surfactant and at least one other surfactant. In one embodiment, laundry detergent composition further comprises adjunct surfactants. In another embodiment, the laundry detergent is substantially free of any adjunct surfactants. As used herein, “adjunct surfactant” means any surfactant not part of the surfactant system of the present invention. As used herein, “substantially free” means less than 0.01 parts by weight. Further, for purposes of clarification, as used herein, “parts by weight” or “weight parts” are used with respect to the sum of the surfactants within the surfactant system only; and are irrespective of any adjunct surfactants that may otherwise be part of the laundry detergent composition.

A. Surfactant Systems Comprising at Least a Binary System With a Sulfonated Fatty Acid Alkyl Ester Surfactant

1. Nonionic Surfactant & a Sulfonated Fatty Acid Alkyl Ester Surfactant

One aspect of the invention provides a composition comprising a surfactant system, wherein the surfactant system comprises at least a Nonionic Surfactant and at least a Sulfonated Fatty Acid Alkyl Ester Surfactant, wherein the weight ratio of the Nonionic Surfactant to the Sulfonated Fatty Acid Alkyl Ester Surfactant is from about 75:25 to about 99:1, alternatively 95:5 to about 99:1, of the Nonionic Surfactant to the Sulfonated Fatty Acid Alkyl Ester Surfactant respectively. In one embodiment, the composition comprising the Nonionic Surfactant and the Sulfonated Fatty Acid Alkyl Ester Surfactant has an average Krafft Temperature below 15° C., alternatively less than 12.2° C., alternatively less than 10° C., alternatively less than 8° C.
2. Alkyl or Alcohol Sulfate Surfactant & a Sulfonated Fatty Acid Alkyl Ester Surfactant

Another aspect of the invention provides a composition comprising a surfactant system, wherein the surfactant system comprises at least an Alkyl or Alcohol Sulfate Surfactant and at least a Sulfonated Fatty Acid Alkyl Ester Surfactant, wherein the weight ratio of the Alkyl or Alcohol Sulfate Surfactant to the Sulfonated Fatty Acid Alkyl Ester Surfactant comprises a range from about 91:9 to about 73:27, alternatively 85:15 to about 79:21 of the Alkyl or Alcohol Sulfate Surfactant to the Sulfonated Fatty Acid Alkyl Ester Surfactant respectively. In one embodiment, the composition comprising the Alkyl or Alcohol Sulfate Surfactant and the Sulfonated Fatty Acid Alkyl Ester Surfactant has a Krafft Temperature below 15° C., alternatively less than about 10° C., alternatively less than about 5° C.
3. Branched Surfactant & an Sulfonated Fatty Acid Alkyl Ester Surfactant

Another aspect of the invention provides a composition comprising a surfactant system, wherein the surfactant system comprises at least a Branched Surfactant and at least a Sulfonated Fatty Acid Alkyl Ester Surfactant, wherein the weight ratio of the Branched Surfactant to the Sulfonated Fatty Acid Alkyl Ester Surfactant comprises a range from about 40:60 to about 99:1, alternatively 45:55 to about 99:1, alternatively about 52:48 to about 99:1, alternatively from about 62:38 to about 99:1, alternatively from about 75:25 to about 85:15, alternatively of the Branched Surfactant to the Sulfonated Fatty Acid Alkyl Ester Surfactant respectively. In one embodiment, the composition comprising the Branched Surfactant and the Sulfonated Fatty Acid Alkyl Ester Surfactant has a Krafft Temperature below 15° C., alternatively less than about 10° C., alternatively less than about 5° C.

In another embodiment, the weight ratio of the Branched Surfactant to the Sulfonated Fatty Acid Alkyl Ester Surfactant comprises a range from about 83:17 to about 77:23, alternatively from about 82:18 to about 78:22, alternatively from about 81:19 to about 79:21, by weight ratio of the Branched Surfactant to the Sulfonated Fatty Acid Alkyl Ester Surfactant, alternatively wherein the composition comprises a Krafft Temperature below about 5° C., more alternatively below about 3° C., alternatively below about 1° C., alternatively below about 0° C.
4. Alkylbenzenesulphonate Surfactant & Sulfonated Fatty Acid Alkyl Ester Surfactant

Another aspect of the invention provides a composition comprising a surfactant system, wherein the surfactant system comprises at least an Alkylbenzenesulphonate Surfactant and at least an Sulfonated Fatty Acid Alkyl Ester Surfactant, wherein the weight ratio of the Alkylbenzenesulphonate Surfactant to the Sulfonated Fatty Acid Alkyl Ester Surfactant comprises a range from about 85:15 to about 99:1, alternatively from about 90:10 to about 98:2 of the Alkylbenzenesulphonate Surfactant to the Sulfonated Fatty Acid Alkyl Ester Surfactant respectively. In one embodiment, the composition comprising the Alkylbenzenesulphonate Surfactant and the Sulfonated Fatty Acid Alkyl Ester Surfactant has a Krafft Temperature below 15° C., alternatively less than about 10° C., alternatively less than about 5° C.

In another embodiment, the Alkylbenzenesulphonate Surfactant to the Sulfonated Fatty Acid Alkyl Ester Surfactant weight ratio is from about 99:1 to about 93:7, alternatively from about 98:2 to about 94:6, alternatively 97:3 to about 95:5, by weight ratio of the Alkylbenzenesulphonate Surfactant to the Sulfonated Fatty Acid Alkyl Ester Surfactant, respectively, alternatively wherein the composition comprises a Krafft Temperature below about 5° C., alternatively below about 4° C., alternatively about 3.7° C.

B. Surfactant Systems Comprising at Least a Ternary System with Sulfonated Fatty Acid Alkyl Ester Surfactant

1. Alkylbenzenesulphonate Surfactant, a Branched Surfactant, & a Sulfonated Fatty Acid Alkyl Ester Surfactant

One aspect of the invention provides a composition comprising a surfactant system, wherein the surfactant system comprises at least the following surfactants in the following weight parts: (a) from about 0 to about 100, alternatively from 0.6 to 35 parts by weight of the alkylbenzenesulphonate surfactant, (b) from about 0 to about 100, alternatively from about 44 to about 53 parts by weight of the branched surfactant, and (c) from about 0 to about 49, alternatively from 22 to 49 parts by weight of the sulfonated fatty acid alkyl ester surfactant, wherein adding the parts by weight of the surfactants of (a)+(b)+(c) total to about 100.

Another aspect of the invention provides a composition comprising a surfactant system, wherein the surfactant system comprises at least the following surfactants in the following weight parts: (a) from about 0.5 to about 35, alternatively from about 1 to about 10 parts by weight of the alkylbenzenesulphonate surfactant, (b) from about 40 to about 78, alternatively from about 44 to about 53 parts by weight of the branched surfactant, and (c) from about 22 to about 49, alternatively from 30 to 40 parts by weight of the sulfonated fatty acid alkyl ester surfactant, wherein adding the parts by weight of the surfactants of (a)+(b)+(c) total to about 100.
2. Alkylbenzenesulphonate Surfactant, a Branched Surfactant, & a Sulfonated Fatty Acid Alkyl Ester Surfactant

One aspect of the invention provides a composition comprising a surfactant system, wherein the surfactant system comprises at least the following surfactants in the following weight parts: (a) from about 33 to about 39 parts, alternatively from about 34 to about 38 parts, or alternatively from about 35 to about 37 parts of an Alkylbenzenesulphonate Surfactant, (b) from about 49 to about 55 parts, alternatively from about 50 to about 54 parts, alternatively from about 51 to about 53 parts of a Branched Surfactant, and (c) from about 9 to about 15 parts, alternatively from about 10 to about 14 parts, alternatively from about 11 to about 13 parts of a Sulfonated Fatty Acid Alkyl Ester Surfactant; wherein the parts of the addition of the surfactants of (a)+(b)+(c) total to about 100.

In an alternative embodiment, the composition comprises a surfactant system wherein the surfactant system comprises at least about the following surfactant in the following weight parts: (a) from about 35 to about 75, alternatively from about 37 to about 43 parts, alternatively from about 38 to about 42 parts, or alternatively from about 39 to about 41 parts of a the Alkylbenzenesulphonate Surfactant, (b) from about 10 to about 50, from about 33 to about 39 parts, alternatively from about 34 to about 38 parts, alternatively from about 35 to about 37 parts of a Branched Surfactant, and (c) from about 10 to about 30, alternatively from about 20 to about 26 parts, alternatively from about 21 to about 25 parts, alternatively from about 22 to about 24 parts of a an alkyl ester surfactant; wherein the parts of the addition of the surfactants of (a)+(b) +(c) total to about 100.

Another aspect of the invention provides a composition comprising a surfactant system, wherein the surfactant system comprises at least the following surfactants in the following weight parts: (a) from about 39 to about 45 parts, alternatively from about 40 to about 44 parts, alternatively from about 41 to about 43 parts of an Alkylbenzenesulphonate Surfactant, (b) from about 34 parts to about 40 parts, alternatively from about 35 to about 39 parts, alternatively from about 36 to about 38 parts of a Branched Surfactant, and (c) from about 17 to about 23, alternatively from about 18 to about 22, alternatively from about 19 to about 21 of a an Sulfonated Fatty Acid Alkyl Ester Surfactant; wherein adding the weight parts of the surfactants of (a)+(b)+(c) total to about 100.

Yet another aspect of the invention provides a composition comprising a surfactant system, wherein the surfactant system comprises at least the following surfactants in the following weight parts: (a) from about 37 to about 43 parts, alternatively from about 38 to about 42 parts, alternatively from about 39 to about 41 parts of an Alkylbenzenesulphonate Surfactant, (b) from about 33 parts to about 39 parts, alternatively from about 34 to about 38 parts, alternatively from about 35 to about 37 parts of a Branched Surfactant, and (c) from about 20 to about 26, alternatively from about 21 to about 25, alternatively from about 22 to about 24 of a an Sulfonated Fatty Acid Alkyl Ester Surfactant; wherein adding the weight parts of the surfactants of (a)+(b)+(c) total to about 100.

One aspect of the invention provides a composition comprising a surfactant system, wherein the surfactant system comprises at least the following surfactants in the following weight parts: (a) from about 67 to about 73 parts, alternatively from about 68 to about 72 parts, alternatively from about 69 to about 71 parts of an Alkylbenzenesulphonate Surfactant, (b) from about 10 parts to about 16 parts, alternatively from about 11 to about 15 parts, alternatively from about 12 to about 14 parts of a Branched Surfactant, and (c) from about 13 to about 19, alternatively from about 14 to about 18, alternatively from about 15 to about 17 of a an Sulfonated Fatty Acid Alkyl Ester Surfactant; wherein adding the weight parts of the surfactants of (a)+(b)+(c) total to about 100.
3. Alkylbenzenesulphonate Surfactant, an Alkyl or Alcohol Sulfate Surfactant, an Sulfonated Fatty Acid Alkyl Ester Surfactant

One aspect of the invention provides a composition comprising a surfactant system, wherein the surfactant system comprises at least the following surfactants in the following weight parts: (a) from about 39 to about 45 parts, alternatively from about 40 to about 44 parts, alternatively from about 41 to about 43 parts of an Alkylbenzenesulphonate Surfactant, (b) from about 33 parts to about 39 parts, alternatively from about 34 to about 38 parts, alternatively from about 35 to about 37 parts of an Alkyl or Alcohol Sulfate Surfactant, and (c) from about 19 to about 25, alternatively from about 20 to about 24, alternatively from about 21 to about 23 of a an Sulfonated Fatty Acid Alkyl Ester Surfactant; wherein adding the weight parts of the surfactants of (a)+(b)+(c) total to about 100.
4. Alkylbenzenesulphonate Surfactant, a Secondary Alkyl or Alcohol Alkoxy Sulfate Surfactant, and an Sulfonated Fatty Acid Alkyl Ester Surfactant

One aspect of the invention provides a composition comprising a surfactant system, wherein the surfactant system comprises at least the following surfactants in the following weight parts: (a) from about 61 to about 67, alternatively from about 62 to about 66, alternatively from about 63 to about 65 parts of an Alkylbenzenesulphonate Surfactant, (b) from about 30 to about 36, alternatively from about 31 to about 35, alternatively from about 32 to about 34 parts of a Secondary Alkyl or Alcohol Alkoxy Sulfate Surfactant, and (c) from about 1 to about 5, alternatively from about 1 to about 4, alternatively from about 2 to about 3 parts, alternatively from about 2 to about 4, alternatively from about 2% to about 3%, parts of an Sulfonated Fatty Acid Alkyl Ester Surfactant; wherein adding the weight parts of the surfactants of (a)+(b)+(c) total to about 100.

C. Surfactant Systems Comprising at Least a Quaternary System That Includes Sulfonated Fatty Acid Alkyl Ester Surfactant

1. Alkylbenzenesulphonate Surfactant, a Branched Surfactant, an Alkyl or Alcohol Sulfate Surfactant, and a Sulfonated Fatty Acid Alkyl Ester Surfactant

One aspect of the invention provides a composition comprising a surfactant system, wherein the surfactant system comprises at least the following surfactants in the following weight part: (a) from about 0 to about 100, alternatively from about 0.6 to about 35 parts by weight of the alkylbenzenesulphonate surfactant, (b) from about 0 to about 91, alternatively from about 18 to about 23 parts by weight of the alkyl or alcohol sulfate surfactant, (c) from about 0 to about 100, alternatively from about 43 to about 53 parts by weight of the branched surfactant, and (d) from about 0 to about 56, alternatively from about 22 to about 36 parts by weight of the sulfonated fatty acid alkyl ester surfactant, wherein adding the parts by weight of the surfactants of (a)+(b)+(c)+(d) total to about 100.

Another aspect of the invention provides a composition comprising a surfactant system, wherein the surfactant system comprises at least the following surfactants in the following weight part: (a) from about 0.5 to about 25, alternatively from about 0.6 to about 1.5 parts by weight of the alkylbenzenesulphonate surfactant, (b) from about 15 to about 40, alternatively from about 18 to about 23 parts by weight of the alkyl or alcohol sulfate surfactant, (c) from about 40 to about 65, alternatively from about 43 to about 53 parts by weight of the branched surfactant, and (d) from about 20 to about 56, alternatively from about 22 to about 36 parts by weight of the sulfonated fatty acid alkyl ester surfactant, wherein adding the parts by weight of the surfactants of (a)+(b)+(c)+(d) total to about 100.
2. Alkylbenzenesulphonate Surfactant, a Branched Surfactant, an Alkyl or Alcohol Sulfate Surfactant, and a Sulfonated Fatty Acid Alkyl Ester Surfactant

One aspect of the invention provides a composition comprising a surfactant system, wherein the surfactant system comprises at least the following surfactants in the following weight part: (a) from about 44 to about 50, alternatively from about 45 to about 49, alternatively from about 46 to about 48 parts of an Alkylbenzenesulphonate Surfactant, (b) from about 25 to about 31, from about 26 to about 30, alternatively from about 27 to about 29 parts of a Branched Surfactant, (c) from about 19 to about 25, alternatively from about 20 to about 24, alternatively from about 21 to about 23 parts of an Alkyl or Alcohol Sulfate Surfactant, and (d) from about 1 to about 3, alternatively from about 1 to about 2 parts of an Sulfonated Fatty Acid Alkyl Ester Surfactant; wherein adding the weight parts of the surfactants of (a)+(b)+(c)+(d) total to about 100.
3. Alkylbenzenesulphonate Surfactant, a Branched Surfactant, an Alkyl or Alcohol Sulfate Surfactant, and a Sulfonated Fatty Acid Alkyl Ester Surfactant

One aspect of the invention provides a composition comprising a surfactant system, wherein the surfactant system comprises at least the following surfactants in the following weight part: (a) from about 32 to about 38, alternatively from about 33 to about 37, alternatively from about 34 to about 36 parts of an Alkylbenzenesulphonate Surfactant, (b) from about 15 to about 21, from about 16 to about 20, alternatively from about 17 to about 19 parts of a Branched Surfactant, (c) from about 27 to about 33, alternatively from about 28 to about 32, alternatively from about 29 to about 31 parts of an Alkyl or Alcohol Sulfate Surfactant, and (d) from about 14 to about 20, alternatively from about 15 to about 19, alternatively 16 to about 18 parts of an Sulfonated Fatty Acid Alkyl Ester Surfactant; wherein adding the weight parts of the surfactants of (a)+(b)+(c)+(d) total to about 100.
4. Alkylbenzenesulphonate Surfactant; a Secondary Alkyl or Alcohol Sulfate Surfactant, a Secondary Alkyl or Alcohol Alkoxy Sulfate Surfactant; & Sulfonated Fatty Acid Alkyl Ester Surfactant

One aspect of the invention provides a composition comprising a surfactant system, wherein the surfactant system comprises at least the following surfactants in the following weight part: (a) from about 39 to about 45, alternatively from about 40 to about 44, alternatively from about 41 to about 43 parts of an Alkylbenzenesulphonate Surfactant, (b) from about 33 to about 39, from about 34 to about 38, alternatively from about 35 to about 37 parts of a Secondary Alkyl or Alcohol Sulfate Surfactant, (c) from about 1 to about 5, alternatively from about 1 to about 4, alternatively from about 1 to about 3 parts of a Secondary Alkyl or Alcohol Alkoxy Sulfate Surfactant, and (d) from about 16 to about 22, alternatively from about 18 to about 22 parts, alternatively from about 20 to about 22 parts of an Sulfonated Fatty Acid Alkyl Ester Surfactant; wherein adding the weight parts of the surfactants of (a)+(b)+(c)+(d) total to about 100.
5. Branched Surfactant, an Alkylbenzenesulphonate Surfactant, a Secondary Alkyl or Alcohol Sulfate Surfactant, & a Sulfonated Fatty Acid Alkyl Ester Surfactant

One aspect of the invention provides a composition comprising a surfactant system, wherein the surfactant system comprises at least the following surfactants in the following weight part: (a) from about 15 to about 21, alternatively from about 16 to about 20, alternatively from about 17 to about 19 parts of an Branched Surfactant, (b) from about 31 to about 38, from about 32 to about 37, alternatively from about 33 to about 36 parts of a Alkylbenzenesulphonate Surfactant, (c) from about 27 to about 33, alternatively from about 28 to about 32, alternatively from about 29 to about 31 parts of an Alkyl or Alcohol Sulfate Surfactant, and (d) from about 14 to about 20, alternatively from about 15 to about 19 parts, alternatively from about 16 to about 18 parts of an Sulfonated Fatty Acid Alkyl Ester Surfactant; wherein adding the weight parts of the surfactants of (a)+(b)+(c)+(d) total to about 100.

D. Surfactant system Comprising at Least a Five-Component Systems That Includes an Alkyl Ester Surfactant

1. Branched Surfactant, a Secondary Alkyl or Alcohol Alkoxy Sulfate, an Alkylbenzenesulphonate Surfactant, a Nonionic Surfactant, and a Sulfonated Fatty Acid Alkyl Ester Surfactant

One aspect of the invention provides a composition comprising a surfactant system, wherein the surfactant system comprises at least the following surfactants in the following weight part: (a) from about 6 to about 12, alternatively from about 7 to about 11, alternatively from about 8 to about 10, parts of a Branched Surfactant, (b) from about 53 to about 59, alternatively from about 54 to about 58, alternatively from about 55 to about 57 parts of a Secondary Alkyl or Alcohol Alkoxy Sulfate, (c) from about 14 to about 20, alternatively from about 15 to about 19, alternatively from about 16 to about 18 parts of an Alkylbenzenesulphonate Surfactant, (d) from about 11 to about 17, alternatively from about 12 to about 16, alternatively from about 13 to about 15 parts of an a Sulfonated Fatty Acid Alkyl Ester Surfactant, and (e) from about 1 to about 4, alternatively from about 2 to about 3 parts of a Nonionic Surfactant; wherein adding the weight parts of the surfactants of (a)+(b)+(c)+(d)+(e) total to about 100.

E. Method of Measuring Krafft Temperature

The present invention is based, in part, upon the observation that although the Krafft Temperature of a Sulfonated Fatty Acid Alkyl Ester Surfactant is relatively high, for example we measured the Krafft Temperature of MES at 24.7° C., yet obtained surfactant systems comprising a Sulfonated Fatty Acid Alkyl Ester Surfactant with significantly lower Krafft Temperatures as to provide effective cold water cleaning.

All samples are measured on the Phase Technology Phase Analyzer system, which determines a Krafft temperature by scanning diffusive light scattering. All samples are made up in distilled water with a total surfactant system concentration of 1%.

The Krafft temperature is measured using the following program: (1) heat the sample to 25° Celsius at a rate of 5° C./min, hold at that temperature for 10 seconds; (2) cool the sample to −15 degrees C. at a rate of 5° C./min, hold the sample at that temperature for 30 seconds; (3) heat the sample to 15° C. at a rate of 2° C./min; and (4) heat the sample to 20° C. at a rate of 5° C./min

When changing samples, the old sample is first absorbed onto a paper towel, and a cotton swab is used to remove all obvious amounts of sample. The chamber is then rinsed with deionized water, which is then absorbed out by towel. The chamber is then rinsed with acetone, and the acetone is absorbed out. Finally, the chamber is rinsed again with deionized water to remove any remaining acetone, and the water is absorbed out, and the chamber is swabbed to remove all traces of water. The chamber is now ready to receive the new sample. 150 microliters of the sample is placed in the chamber, and the chamber door is closed and locked. If the program is loaded, then change the sample identification in the Sample ID box, and hit “Start Run”. Without intending to be bound by theory it is now believed that the Krafft Temperature can be calculated as the point where the curve flattens out during the heating cycle.

F. Surfactant System

In addition to the sulfonated fatty acid alkyl ester surfactant, the surfactant system of the present invention comprises other surfactants. Other surfactants may include one more of the following: anionic surfactants, nonionic surfactants, cationic surfactants, amphoteric surfactants, zwitterionic surfactants, soap, fatty acids, or combinations thereof. In one embodiment, the surfactant system is free or substantially free of one more of these or other surfactants.

Illustrative examples of other surfactants suitable for use herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, in U.S. Pat. No. 4,239,659, Murphy, issued Dec. 16, 1980, U.S. Pat. No. 4,285,841, Barrat et al, issued Aug. 25, 1981, U.S. Pat. No. 4,284,532, Leikhim et al, issued Aug. 18, 1981, U.S. Pat. No. 4,285,841, U.S. Pat. No. 3,919,678 and in U.S. Pat. Nos. 2,220,099 and 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M. C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch). See also Surfactant Science Series, Volumes 67 and 129, published by Marcel Dekker, NY, pertaining to liquid detergents and therein especially the chapters pertaining to heavy-duty liquid laundry detergents.

The compositions of the present invention comprise from about 1% to about 99%, alternatively from about 2% to about 30%, alternatively from about 3% to about 20%, of the surfactant system by weight of the composition. In one embodiment, the composition comprises a liquid laundry detergent composition, wherein the surfactant system comprises from about 20% to about 40%, alternatively 25% to about 35%, by weight of the composition. In yet another embodiment, the composition comprises a laundry powder detergent composition, wherein the surfactant system comprises from about 7% to about 30%, alternatively 15% to about 25%, alternatively 16% to about 20%, by weight of the composition

The compositions of the present invention may be in the form of a powder, granular, flowable liquid, gel or paste. The compositions are suitable for use in laundry cleaning, hard surface cleaning, hand dish cleaning, automatic dish cleaning, and the like.
1. Sulfonated Fatty Acid Alkyl Ester Surfactant

One aspect of the invention provides compositions comprising a Sulfonated Fatty Acid Alkyl Ester Surfactants. The term “Sulfonated Fatty Acid Alkyl Ester Surfactant comprises those surfactants of the formula: 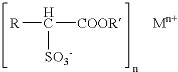
wherein R is, on the average, a C₄ to C₂₂ alkyl, R′ is on the average a C₁ to C₈ alkyl, M is an alkali metal or alkaline earth metal cation, or a mixture thereof, and n is 1 when M is an alkali metal cation and n is 2 when M is an alkaline earth metal cation.

The hydrophobic portion of these sulfonated alkyl esters have the sulfonate group at the α-position, i.e., the sulfonate group is positioned at the carbon atom adjacent the carbonyl group. The alkyl portion of the hydrophobic portion, which corresponds to the R portion of the sulfonated fatty acid alkyl esters, is on the average a C₄ to C₂₂ alkyl. In one embodiment, the alkyl portion of this hydrophobic portion, R, is on the average a saturated straight-chain C₁₀ to C₁₆ hydrocarbon particularly when R′ is methyl.

R′, forming the ester portion of the sulfonated alkyl esters, is on the average a C₁ to C₈ alkyl. In one embodiment, R′ is on the average a C₁ to C₆ alkyl. In another embodiment R′ is a C₁ alkyl, i.e., methyl.

When considered together, for a number of embodiments of the compositions of the present invention (including but not limited to heavy duty laundry compositions), R and R′ contain a total of about 11 to 17 carbons distributed between them. In one embodiment the distribution is such that R is, on the average, a C₁₄ to C₁₆ alkyl (approximately, for example, a 95% C₁₄, 5% C₁₆ mix) and R′ is methyl. In another embodiment, the distribution is such that R is, on the average, a C₁₂ to C₁₆ alkyl (approximately, for example, a 3% C₁₂, 28% C₁₄, 69% C₁₆) and R′ is methyl. In yet another embodiment, the distribution is such that R is, on the average, a C₁₀ to C₁₆ alkyl (approximately, for example, a 60% C₁₀, 35% C₁₂ 5% C₁₄) and R′ is methyl. In yet further another embodiment, the distribution is such that R is, on the average, a C₁₀ to C₁₆ alkyl (approximately, for example, a 60% C₁₄, 40% C₁₆) and R′ is methyl. In yet still another embodiment, R is derived from a naturally occurring (plant or animal) fatty acid such a palmic acid or stearic acid or mixtures thereof. In yet a further embodiment, blends of the aforementioned distributions of R and R′ may also be employed.

The cationic portion, M, is an alkali metal or alkaline earth metal cation or mixture thereof. In one embodiment, M is chosen from sodium, potassium, lithium, magnesium and calcium, and mixtures thereof. In another embodiment, M is sodium or a mixture containing sodium. When M is an alkali metal cation (valence=1) n is 1 and when M is an alkaline earth metal cation (valence=2) n is 2.

Methods of making alkyl ester surfactants have been well described and are known to those skilled in art the art. See U.S. Pat. Nos. 4,671,900; 4,816,188; 5,329,030; 5,382,677; 5,384,422; 5,475,134; 5,587,500; 6,780,830. Huish is a supplier of MES.
2. Alkylbenzenesulphonate Surfactant

One aspect of the invention provides the use an “Alkylbenzenesulphonate Surfactant” as part of the surfactant system. These include the hard (ABS, TPBS), linear types, also known as LAS, and made by known process such as various HF or solid HF e.g., DETAL® (UOP) process, or made by using other Lewis Acid catalysts e.g., AlCl₃, or made using acidic silica/alumina or made from chlorinated hydrocarbons, such as C₉-C₂₀ linear alkylbenzene sulfonates, particularly sodium linear alkyl C₁₀-C₁₅ benzene sulfonate. In one embodiment, the Alkylbenzenesulphonate Surfactant is a water soluble salt or acid typically of the formula R-A-SO₃-M wherein R is a branched or linear C₁₀-C₂₄ alkyl group, alternatively a C₁₀-C₂₀ alkyl, alternatively a C₁₀-C₁₈ alkyl, A is an aryl group, such as benzene or toluene. In one embodiment, A is a benzene unit, and M is H or a cation which can be, for example, a metal cation (e.g., sodium, potassium, lithium, etc.), ammonium or substituted-ammonium cation.

In one embodiment, the synthesis of the Alkylbenzenesulphonate Surfactant of the present invention is a result of an alkylation step, such that the alkylation step has an “internal isomer selectivity” or “IIS” in the range of from 40 to 80, alternatively from 60 to 80, alternatively from 70 to 80. The Internal Isomer Selectivity or “IIS” as defined herein is measured for any given alkylation process step by conducting a test alkylation of benzene by 1-dodecene at a molar ratio of 10:1. The alkylation is conducted in the presence of an alkylation catalyst to a conversion of dodecene of at least 90% and formation of monophenyldodecanes of at least 60%. Internal isomer selectivity is then determined as:

$$IIS = 100 * ( 1 - \frac{amount of terminal phenyldodecanes}{amount of total phenyldodecanes} )$$

wherein amounts are amounts of the products by weight; the amount of terminal phenyldodecanes is the amount of the sum of 2-phenyldodecane and 3- phenyldodecane and the amount of total phenyldodecanes is the amount of the sum of 2-phenyldodecane and 3-phenyldodecane and 4-phenyldodecane and 5- phenyldodecane and 6-phenyldodecane and wherein said amounts are determined by any known analytical technique for alkylbenzenesulfonates such as gas chromatography. See Analytical Chemistry, Nov. 1983, 55 (13), 2120-2126, Eganhouse et al, “Determination of long-chain alkylbenzenes in environmental samples by argentation thin-layer chromatography—high resolution gas chromatography and gas chromatography/mass spectrometry”. In computing IIS according to the above formula, the amounts are divided before subtracting the result from 1 and multiplying by 100. It should of course be understood that the specific alkenes used to characterize or test any given alkylation step for suitability are reference materials permitting a comparison of the alkylation step herein with known alkylation steps as used in making linear alkylbenzenes and permitting the practitioner of the invention to decide if a given known alkylation step is, or is not, useful in the context of the series of process steps constituting the present invention. See U.S. Pat. No. 6,602,840.

It should be appreciated that a high IIS values means a relatively low amount of 2-phenyl and 3-phenyl moieties in the Alkylbenzenesulphonate Surfactant.

LAS is also described in U.S. Pat. Nos. 2,220,099; and 2,477,383.
3. Branched Surfactant

The surfactant system of the present invention can also comprise mid-chain branched surfactants (collectively herein referred to as a “Branched Surfactant”), including but not limited to mid-chain branched alkyl alkoxy alcohols having the formula: 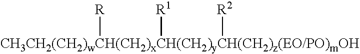
mid-chain branched alkyl sulfates having the formula: 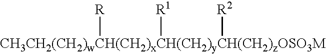
and mid-chain branched alkyl alkoxy sulfates having the formula: 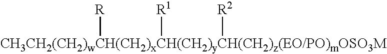
wherein the total number of carbon atoms in the branched primary alkyl moiety of these formulae (including the R, R¹, and R² branching, but not including the carbon atoms which comprise any EO/PO alkoxy moiety) is from 14 to 20, and wherein further for this surfactant mixture the average total number of carbon atoms in the branched primary alkyl moieties having the above formula is within the range of greater than 14.5 to about 17.5 (alternatively from about 15 to about 17); R, R¹, and R² are each independently selected from hydrogen, C₁-C₃ alkyl, and mixtures thereof, including but not limited to methyl; provided R, R¹, and R² are not all hydrogen and, when z is 1, at least R or R¹ is not hydrogen. M is a water soluble cation and may comprises more than one type of cation, for example, a mixture of sodium and potassium. The index w is an integer from 0 to 13; x is an integer from 0 to 13; y is an integer from 0 to 13; z is an integer of at least 1; provided w+x+y+z is from 8 to 14. EO and PO represent ethyleneoxy units and propyleneoxy units having the formula: 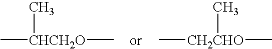
respectively, however, other alkoxy units inter alia 1,3-propyleneoxy, butoxy, and mixtures thereof are suitable as alkoxy units appended to the mid-chain branched alkyl moieties.

In one embodiment, the mid-chain branched surfactants are mixtures which comprise a surfactant system. Therefore, when the surfactant system comprises an alkoxylated surfactant, the index m indicates the average degree of alkoxylation within the mixture of surfactants. As such, the index “m” is at least about 0.01, alternatively within the range of from about 0.1, alternatively from about 0.5, alternatively from about 1 to about 30, alternatively to about 10, alternatively to about 5. When considering a mid-chain branched surfactant system which comprises only alkoxylated surfactants, the value of the index “m” represents a distribution of the average degree of alkoxylation corresponding to m, or it may be a single specific chain with alkoxylation (e.g., ethoxylation and/or propoxylation) of exactly the number of units corresponding to m.

The preferred mid-chain branched surfactants of the present invention which are suitable for use in the surfactant systems of the present invention have the formula: 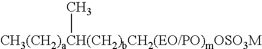
or the formula: 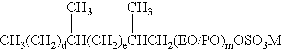
wherein a, b, d, and e are integers such that a+b is from 10 to 16 and d+e is from 8 to 14; M is selected from sodium, potassium, magnesium, ammonium and substituted ammonium, and mixtures thereof.

In one embodiment, the surfactant systems of the present invention which comprise mid-chain branched surfactants are formulated in two embodiments. A first preferred embodiment comprises mid-chain branched surfactants which are formed from a feedstock which comprises 25% or less of mid-chain branched alkyl units. Therefore, prior to admixture with any other conventional surfactants, the mid-chain branched surfactant component will comprise 25% or less of surfactant molecules which are non-linear surfactants.

A second preferred embodiment comprises mid-chain branched surfactants which are formed from a feedstock which comprises from about 25% to about 70% of mid-chain branched alkyl units. Therefore, prior to admixture with any other conventional surfactants, the mid-chain branched surfactant component will comprise from about 25% to about 70% surfactant molecules which are non-linear surfactants.

Shell (Neodol® 67); Sasol (Safol® series of compounds); are a suppliers of Branched Surfactants.

Branched Surfactants are also discussed in U.S. Pat. Nos. 5,780,694; 5,849,960; 6,015,781; 6,020,303; 6,060,443; 6,133,222; 6,228,829;
4. Secondary Alkyl or Alcohol (Alkoxy) Sulfate

Secondary Alkyl or Alcohol Alkoxy Sulfate Surfactants are another category of an anionic surfactant that may comprise the surfactant system of the present invention. These surfactants are water soluble salts or acids typically of the formula R—O-(A)ₘ-SO₃-M wherein R is an unsubstituted C₁₀-C₂₄ alkyl or hydroxyalkyl group having a C₁₀-C₂₄ alkyl component, alternatively a C₁₂-C₂₀ alkyl or hydroxyalkyl, alternatively C₁₂-C₁₈ alkyl or hydroxyalkyl, A is an ethoxy or propoxy unit, m is greater than zero, typically between about 0.5 and about 6, alternatively between about 0.5 and about 3, and M is H or a cation which can be, for example, a metal cation (e.g., sodium, potassium, lithium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines, e.g. monoethanolamine, diethanolamine, and triethanolamine, and mixtures thereof. Exemplary surfactants are C₁₂-C₁₈ alkyl polyethoxylate (1.0) sulfate, C₁₂-C₁₈ alkyl polyethoxylate (2.25) sulfate, C₁₂-C₁₈ alkyl polyethoxylate (3.0) sulfate, and C₁₂-C₁₈ alkyl polyethoxylate (4.0) sulfate wherein M is conveniently selected from sodium and potassium.

Secondary Alkyl or Alcohol Sulfate Surfactants may comprise the surfactant system of the present invention, wherein the surfactant comprises the formula R—O-SO₃-M, wherein R is a C₁₀-C₂₄ hydrocarbyl, alternatively an alkyl or hydroxyalkyl having a C₁₀-C₂₀ alkyl component, alternatively a C₁₂-C₁₈ alkyl or hydroxyalkyl, and M is H or a cation, e.g., an alkali (Group IA) metal cation (e.g., sodium, potassium, lithium), substituted or unsubstituted ammonium cations such as methyl-, dimethyl-, and trimethyl ammonium and quaternary ammonium cations, e.g., tetramethyl-ammonium and dimethyl piperdinium, and cations derived from alkanolamines such as ethanolamine, diethanolamine, triethanolamine, and mixtures thereof, and the like. In one embodiment, the alkyl chains are C₁₂-C₁₆, alternatively C₁₄-C₁₅, alternatively C₁₂-C₁₅ or combinations thereof.

Surfactants for use herein can be made from natural or synthetic alcohol feedstocks. Chain lengths represent average hydrocarbon distributions, including branching. The anionic surfactant component may comprise alkyl sulfates and alkyl ether sulfates derived from conventional alcohol sources, e.g., natural alcohols, synthetic alcohols such as those sold under the trade name of NEODOL™, ALFOL™, LIAL™, LIALET™, LUTENSOL™, TERGITOL™ (from Dow Chemical) and the like. Alkyl ether sulfates are also known as alkyl polyethoxylate sulfates.
5. Nonionic Surfactants

Another aspect of the invention provides a surfactant system that comprises a Nonionic Surfactant. Non-limiting examples of Nonionic Surfactants that may be used in addition to the solubilizing nonionic surfactants of the present invention include C₁₂-C₁₈ alkyl ethoxylates, such as those derived from NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as PLURONIC® from BASF; C₁₄-C₂₂ mid-chain branched alcohols, as discussed in U.S. Pat. No. 6,150,322; C₁₄-C₂₂ mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; Polyhydroxy fatty acid amides (GS-base) as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.
6. Adjunct Ingredients

Suitable adjunct ingredients include any ingredients which are conventionally included in detergent compositions. Suitable adjunct ingredients may be selected from the group consisting of enzymes, bleaches, surfactants, perfumes, co-solvents, cleaning agents, antibacterial agents, antistatic agents, brighteners, dye fixatives, dye abrasion inhibitors, anti-crocking agents, wrinkle reduction agents, wrinkle resistance agents, soil release polymers, sunscreen agents, anti-fade agents, builders, sudsing agents, composition malodor control agents, dyes, colorants, speckles, pH buffers, waterproofing agents, soil repellency agents, and mixtures thereof.

Non-limiting examples of adjunct ingredients that may be suitable are disclosed in U.S. Pat. Nos. 6,488,943; 6,514,932; 6,548,470; 6,482,793; 5,545,350; 6,083,899; 6,156,722; 6,573,234; 6,525,012; 6,551,986; 6,566,323; 6,090,767; and 6,420,326.

G. Method of Making Powder or Granular Laundry Detergent

Another aspect of the invention provides way of incorporating MES into the laundry detergent composition of the present invention. In one embodiment, the MES is admixed as 70-99%, alternatively 80-90%, alternatively 85% to about 89%, active particle, by weight of the particle. The active particle may be added directly to the laundry composition or agglomerated with other components. The active particle may be obtained from Huish.

In another embodiment, the MES paste is agglomerated with other detergent components such as, but not limited to, surfactant, builder (e.g., zeolite, carbonate), polymers, and the like, or combinations thereof. In this embodiment, the agglomerate comprising MES is, in turn, added to the detergent composition.

### EXAMPLES

### Example 1

A powder laundry detergent composition, comprising a granule and/or agglomerate, is provided comprising a surfactant system, wherein the surfactant system comprises 17.25% of the total of weight of the composition, wherein the surfactant system is 40.5 weight parts of LAS, 36.25 weight parts of a Branched Surfactant, wherein the Branched Surfactant is sulfonated Neodol™ 67 from Shell, and 23.15 weight parts of methyl ester sulfonate monosalt. Other components of the composition on a weight percentage include: 21.45% Zeolite; 34.06% sodium carbonate; 7.45% moisture; 4.69% sodium sulfate; 4.63% nonanoyloxybenzenesulfonate; 5.64% percarbonate; and other ingredients to total 100%. A dose of approximately 65 g is recommended to the user such that the average approximately a 64 L washer is delivered a total of about 173.19 part per million of the surfactant system.

### Example 2

A liquid laundry detergent is provided comprising a surfactant system, wherein the surfactant system comprises about 31.5% of the total of weight of the composition, wherein the surfactant system is: 9.52 weight parts of a Branched Surfactant (sulfonated Neodol™ 67 (Shell)), 56.18 weight parts of an alcohol ethoxylate sulfate, 17.46 weight parts of LAS, 14.29 weight parts of a methyl ester sulfonate, and 2.55 weight parts of a Nonionic Surfactant. Other components of the composition on a weight percentage basis include: 5.4% of builder; 3.99 of enzymes and stabilizers; 3.85% of performance additives; 16.34% of stabilizers; 0.01% suds suppressor; 0.51% of aesthetics. A dose is recommended to the user such that to an average 64 L washer is delivered a total of about 247 parts per million of the surfactant system.

### Examples 3-7

### Surfactant Systems

| | Alkylbenzene | | Alkyl or Alcohol | Sulfonated Fatty | |
|---|---|---|---|---|---|
| | sulphonate | Branched | Sulfate | Acid Alkyl Ester | Krafft |
| Example | Surfactant | Surfactant | Surfactant | Surfactant | Temp ° C. |
| 3 | 0.013 | 0.531 | 0.227 | 0.229 | 5.3 |
| 4 | 0.010 | 0.440 | 0.188 | 0.362 | 9.6 |
| 5 | 0.006 | 0.463 | 0.199 | 0.332 | 8.6 |
| 6 | 0.006 | 0.464 | 0.199 | 0.331 | 8.5 |
| 7 | 0.006 | 0.463 | 0.198 | 0.332 | 8.6 |

Examples 3 to 7 are provided in parts by weight measurements.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. Further, as used herein “about” means within 0.01 parts by weight.

All documents cited in the Detailed Description of the Invention are, in relevant part, incorporated herein by reference; the citation of any document is not to be construed as an admission that it is prior art with respect to the present invention.

All documents cited in the DETAILED DESCRIPTION OF THE INVENTION are, in the relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. cm What is claimed is:

1. A laundry detergent composition comprising a surfactant system comprising:
a. sulfonated fatty acid alkyl ester surfactant;
b. an alkylbenzenesulphonate surfactant;
c. a branched surfactant;
d. an alkyl or alcohol sulfate surfactant, and
e. a Krafft Temperature below about 15° C.

2. The laundry detergent composition of claim 1, wherein the surfactant system comprises:
a. from about 44 to about 50 parts by weight of the alkylbenzenesulphonate surfactant;
b. from about 25 to about 31 parts by weight of the branched surfactant;
c. from about 19 to about 25 parts by weight of the alkyl or alcohol sulfate surfactant; and
d. from about 1 to about 3 parts by weight of the sulfonated fatty acid alkyl ester surfactant,
wherein adding the parts by weight of the surfactants of (a)+(b)+(c)+(d) total to about 100 parts by weight of the surfactant system.

3. The laundry detergent composition of claim 1, wherein the surfactant system comprises:
a. from about 32 to about 38 parts by weight of the alkylbenzenesulphonate surfactant;
b. from about 15 to about 21 parts by weight of the branched surfactant;
c. from about 27 to about 33 parts by weight of the alkyl or alcohol sulfate surfactant; and
d. from about 14 to about 20 parts by weight of the sulfonated fatty acid alkyl ester surfactant,
wherein adding the parts by weight of the surfactants of (a)+(b)+(c)+(d) total to about 100 parts by weight of the surfactant system.

4. The laundry detergent composition of claim 1, wherein the surfactant system comprises:
a. from about 0.5 to about 25 parts by weight of the alkylbenzenesulphonate surfactant;
b. from about 15 to about 40 parts by weight of the alkyl or alcohol sulfate surfactant;
c. from about 40 to about 65 parts by weight of the branched surfactant; and
d. from about 20 to about 56 parts by weight of the sulfonated fatty acid alkyl ester surfactant,
wherein adding the parts by weight of the surfactants of (a)+(b)+(c)+(d) total to about 100 parts by weight of the surfactant system.

5. The laundry detergent composition of claim 1, wherein said alkyl or alcohol sulfate surfactant comprises a secondary alkyl or alcohol sulfate surfactant.

6. The laundry detergent composition of claim 5, wherein the surfactant system comprises:
a. from about 31 to about 38 parts by weight of the alkylbenzenesulphonate surfactant;
b. from about 27 to about 33 parts by weight of the secondary alkyl or alcohol sulfate surfactant;
c. from about 15 to about 21 parts by weight of the branched surfactant; and
d. from about 14 to about 20 parts by weight of the sulfonated fatty acid alkyl ester surfactant,
wherein adding the parts by weight of the surfactants of (a)+(b)+(c)+(d) total to about 100 parts by weight of the surfactant system.

7. The laundry detergent composition of claim 1, further comprising a nonionic surfactant.

8. The laundry detergent composition of claim 7, wherein the surfactant system comprises:
a. from about 6 to about 12 parts by weight of the branched surfactant;
b. from about 53 to about 59 parts by weight of the secondary alkyl or alcohol sulfate surfactant;
c. from about 14 to about 20 parts by weight of the alkylbenzenesulphonate surfactant;
d. from about 1 to about 4 parts by weight of the nonionic surfactant; and
e. from about 11 to about 17 parts by weight of the sulfonated fatty acid alkyl ester surfactant.
wherein adding the parts by weight of the surfactants of (a)+(b)+(c)+(d)+(e) total to about 100 parts by weight of the surfactant system.

9. A laundry detergent composition comprising a surfactant system comprising:
a. from about 0.5 to about 35 parts by weight of a alkylbenzenesulphonate surfactant;
b. from about 40 to about 78 parts by weight of a branched surfactant;
c. from about 22 to about 49 parts by weight of a sulfonated fatty acid alkyl ester surfactant; and
d. a Krafft Temperature below about 15° C.,
wherein adding the parts by weight of the surfactants of (a)+(b)+(c) total to about 100 parts by weight of the surfactant system.

10. A laundry detergent composition comprising:
a. from about 7 weight % to about 30 weight % of the laundry detergent composition of a surfactant system comprising:
i. from about 35 to about 75 parts by weight of a alkylbenzenesulphonate surfactant;
ii. from about 10 to about 50 parts by weight of a branched surfactant; and
iii. from about 10 to about 30 parts by weight of the sulfonated fatty acid alkyl ester surfactant; and
b. a Krafft Temperature below about 15° C.,
wherein adding the parts by weight of the surfactants of (a)+(b)+(c) total to about 100 parts by weight of the surfactant system, and
wherein the laundry detergent composition is a granular or powder laundry detergent composition.
